(19) United States
(12) Patent Application Publication
(10) Pub. No.: US 2025/0130487 A1
(43) Pub. Date: Apr. 24, 2025

(54) PORTABLE DISPLAY DEVICE WITH COLLAPSIBLE AND REMOVEABLE SCREEN

(71) Applicant: Arovia, Inc., Macungie, PA (US)

(72) Inventors: Shengliang Zhu, Houston, TX (US); Alexander David Wesley, Houston, TX (US)

(73) Assignee: Arovia, Inc., Macungie, PA (US)

(21) Appl. No.: 18/681,576

(22) PCT Filed: Aug. 9, 2022
(86) PCT No.: PCT/US2022/039809

§ 371 Date: Feb. 6, 2024

Related U.S. Application Data
(60) Provisional application No. 63/230,818, filed on Aug. 9, 2021.
(60) Provisional application No. 63/273,887, filed on Oct. 30, 2021.

(51) Int. Cl. G03B 21/58

(52) U.S. Cl. CPC G03B 21/58

(57) ABSTRACT

The present disclosure provides a portable display device with an attached collapsible screen that is removeable, which may be employed as a portable display device with the screen removed, and where the device can be stored in a compact and portable form with the attached screen in a collapsed state and provide a large, attached screen for display when erected and arms for adjusting images on said screen when erected.

### TECHNICAL FIELD OF THE INVENTION

This invention relates to portable display devices with collapsible attached screens that are removeable.

### BACKGROUND OF THE INVENTION

Displays have been used in multiple sizes and configurations in conference rooms, homes, hotels, offices, and other locations for displaying information. Such displays may be portable or built into a room, like a conference room. In addition, projection televisions and other projectors are used for larger audiences. There are also small projector systems that are available for displaying information.

### SUMMARY OF THE INVENTION

The Splay device of this disclosure is a portable display device that has multiple embodiments. The present disclosure provides a portable display device with an attached collapsible and removeable screen, which may be employed as a portable projector with the screen removed, and where the device can be stored in a compact and portable form with the attached screen in a collapsed state and provide a large, attached screen when erected. The device includes a built-in projector with improved screen and shroud materials and deployment features. The prototypes are actual embodiments of a display device with a collapsible and removeable screen used in a portable display device. In addition, improved materials are provided for the collapsible screen and connecting it to a shroud.

These and other features of the disclosure will become apparent to those skilled in the art from the following detailed description of the invention, taken together with the accompanying drawings.

### BRIEF DESCRIPTION OF THE DRAWINGS

FIG. 1A shows the rear side view of one embodiment.

FIG. 1B shows a front side view of the embodiment of FIG. 1A.

FIG. 1C shows a cutaway version of a portion of the shroud of an embodiment.

FIG. 2A shows an exemplary arm of one embodiment in the retracted position.

FIG. 2B shows an exemplary arm of one embodiment in the popped-up position.

FIGS. 3A, 3B, and 3C show the device of FIG. 2A in its top, left, and front views, respectively.

FIG. 4A shows a dis-assembled and exploded view of a portion of the device in FIG. 2B.

FIGS. 4B and 4C show the reverse side of portions of the device of FIG. 4A.

FIG. 5A shows an alternative embodiment to FIG. 2A.

FIG. 5B shows an interior view of a projector and portions of the supporting electronics in a main body.

FIGS. 6A, 6B, and 6C show a representative image, a representative shifted image, and a representative twisted image, respectively.

FIGS. 7A through 7D show the different positions of one exemplary arm from collapsed to extended (popped up).

FIG. 7E shows a detailed view of a portion of one exemplary arm of one embodiment.

FIG. 7F shows an expanded view of a portion of one exemplary arm of one embodiment.

FIG. 7G shows an exemplary arm of FIG. 7E without a plate.

FIGS. 8A and 8B show one exemplary arm in two states, with FIG. 8B showing the arm tensioning the screen.

FIGS. 8C and 8D show a prior arm without a sliding mechanism, with 8D showing the arm unable to extend to tension the screen and already starting to bend.

FIGS. 9A and 9B show exemplary arms on the left side of the device have different section lengths from the right ones.

FIGS. 10A and 10B show the way the exemplary arms attach to the slider and front plate of the main body.

FIG. 11 shows the sliding member moved backwards (direction D4) off the main body after unlocking the buckle. (Shroud is not shown covering the arms in FIG. 11)

FIG. 12A shows the overview of one embodiment for a screen.

FIG. 12B shows the detailed view of one corner of the screen material.

FIG. 13A shows the device in FIG. 1A upside down.

FIG. 13B shows a closeup of one embodiment at how the shroud attaches to the slider.

FIGS. 14A, 14B, and 14C show a first representative distorted image, a second representative distorted image, and a third representative distorted image, respectively.

FIG. 15A shows a detailed view of a portion of one exemplary arm of one embodiment.

FIG. 15B shows an expanded view of a portion of one exemplary arm of one embodiment.

### DETAILED DESCRIPTION

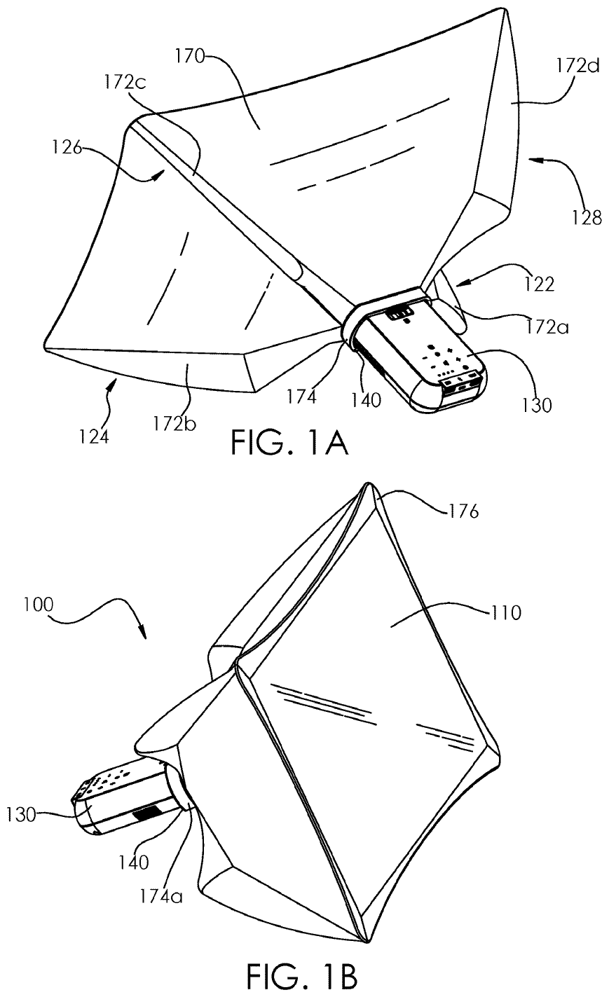

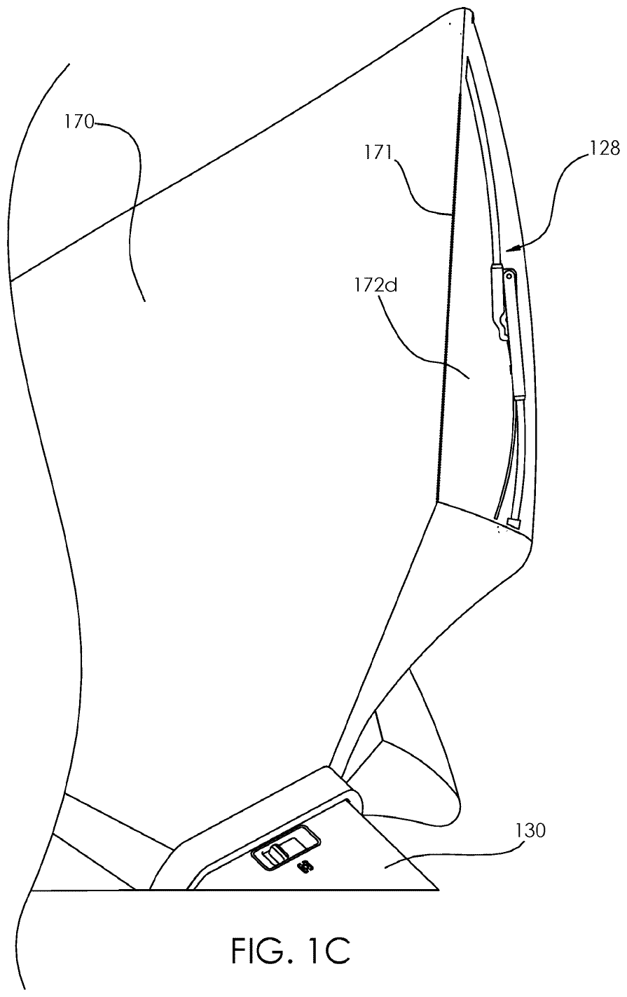

The present disclosure provides embodiments of a Splay device. The Splay device is a portable display device with a collapsible attached screen that is removeable, where the device with the screen can be stored in a compact portable form and then provides a large, attached screen when in use as a portable display device. FIGS. 1 depict embodiments 100 of the portable Splay device of the present disclosure with the collapsible attached screen fully deployed for viewing. When the collapsible attached screen is deployed and properly tensioned, the device 100 may be used as a portable projection display. When the screen is removed, the projector in the main body may be employed as a projector for displaying images on various surfaces (such as for example, but not limited to a wall).

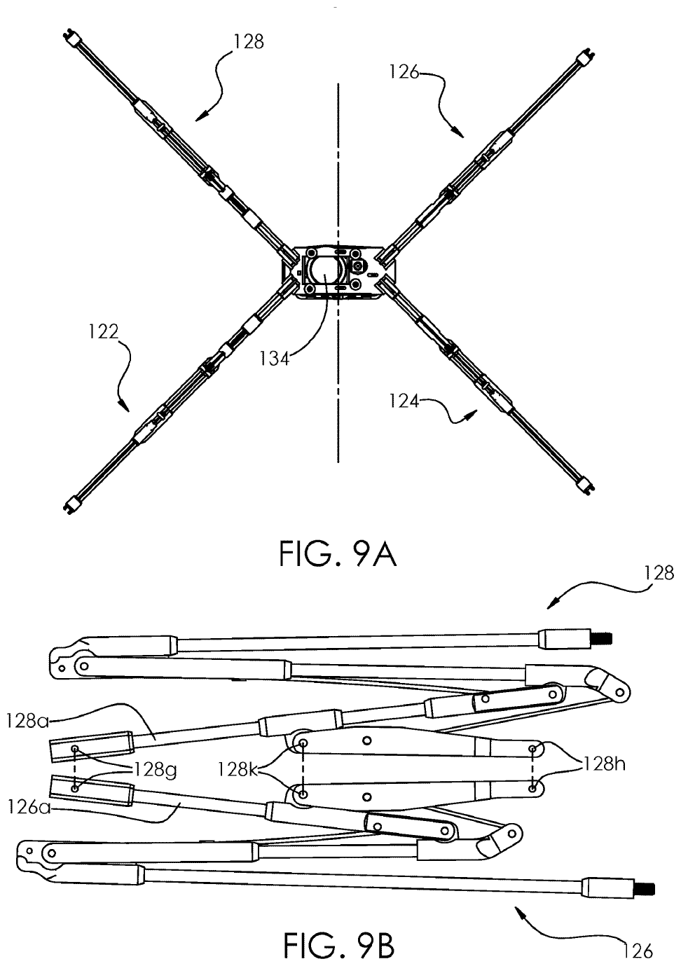

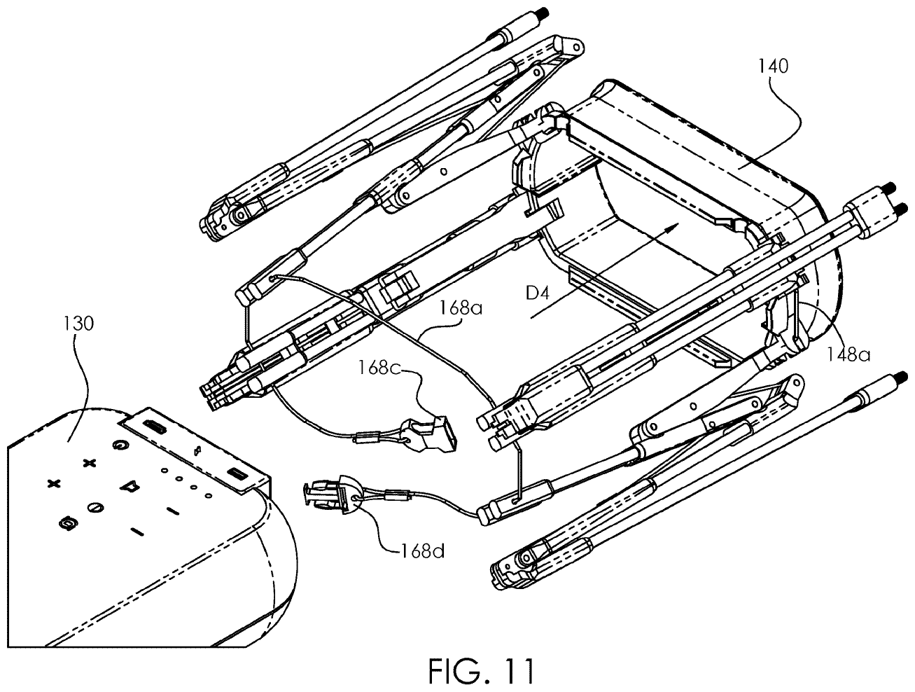

Referring now to FIG. 1A, there may be seen one embodiment of the portable display device 100 of the present disclosure with the collapsible attached screen in a fully extended operating position. More particularly, it may be seen that this embodiment 100 has a fully extended display screen 110 (viewable in FIG. 1B) and four collapsible and extendable arms 122, 124, 126, 128 attached at the corners of the screen and that each of the arms are also attached to a corresponding location on a main body portion 130; the four arms are viewable in FIG. 9A and FIG. 11. Each arm has two attachment points on the body. One rotatable attachment of each arm is to a fixed non-moving portion of the main body 130, and the other rotatable attachment of each arm is to moveable sliding member 140 disposed on or around the main body or housing that is described in more detail later herein. Note that each arm has multiple joints that allow for collapsing and folding the arms and the screen, as described in more detail later herein. However, each arm may have more than two joints. Further, two arms on one side may be slightly longer than the other two arms.

There may also be seen a shroud 170 as shown in FIG. 1C. The shroud 170 encloses the collapsible folding arms, the screen, and the whole trapezoidal volume spanned by the four folding arms attached to four corners of the screen. Any embodiment using a shroud 170 requires the portable display device with a collapsible attached screen to be a rear projection device because the back of the device is covered by the shroud. The shroud 170 is made of polyester fabric or any other suitable fabric or flexible and soft material, and it is preferably of some dark color to absorb ambient light. The fabric preferably is wrinkle resistant. The shroud 170 blocks external light to improve the contrast of the image on the screen, stops dust from getting inside any optical system of a projector that may be located in the body 130, and prevents other people from seeing the screen from the back side.

Continuing to refer to FIG. 1A, sliding member 140 is disposed on the exterior of the housing 130 and is used to push the two ends of the folding collapsible arms 122, 124, 126, 128, rotatably connected to the main body 130, toward each other and cause the arms to fully extend to position the screen in the operating deployed or popped-up position. A first end of each folding collapsible arm is connected to the housing 130 via a rotatable axis that is fixed. A second end of each folding collapsible arm is connected to a rotatable axis on the sliding member 140. When the device 100 is initially in a closed position, the sliding member 140 is located at the back of the device main housing 130. To pop-up the folding collapsible arms, the sliding member 140 is pushed forward. The sliding member 140 may be constructed to be self-latching (so as to not slide back) automatically when the arms are fully extended. Other embodiments may employ a spring (or other mechanical energy storage device) to move sliding member 140 forward to pop- up screen 110. For these embodiments a separate latch mechanism is used to keep the device stored and is pushed or activated and released to allow the sliding member 140 to slide forward and pop-up screen 110.

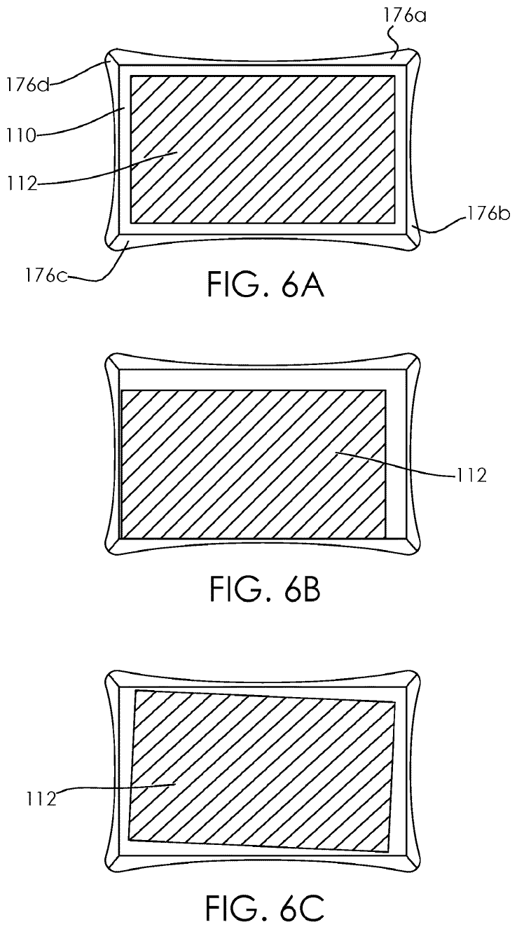

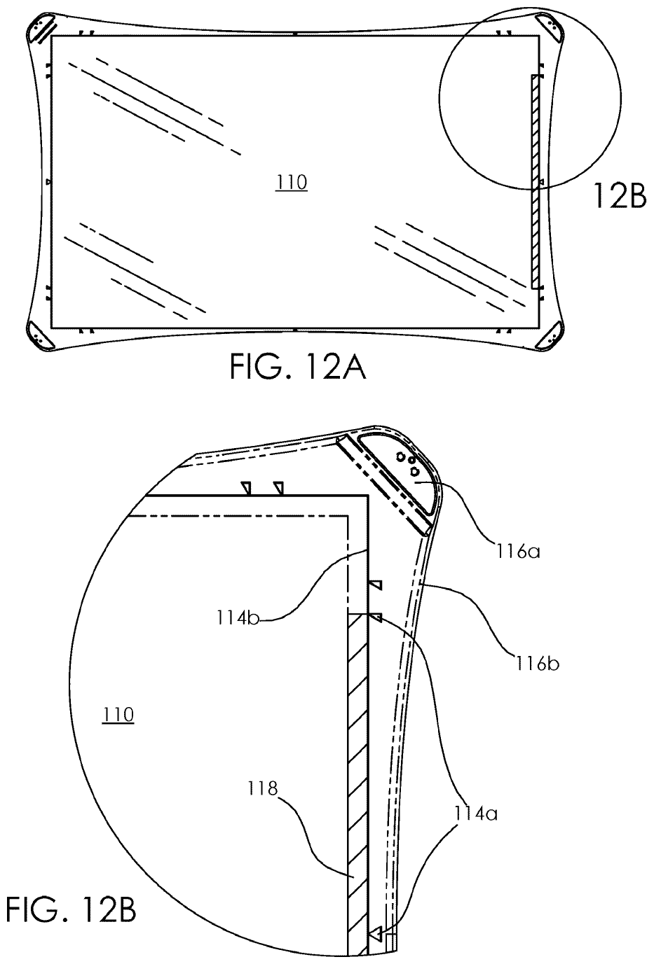

Screen 110 is appropriately tensioned using the extended folding collapsible arms 122, 124, 126, 128 that are connected to and support the screen in its extended display position. One end of the folding arms 120, 122, 124, 126 is connected to the corners of a rectangular screen 110 and provides the outward force to tension the screen. Depending on how tensioned the screen is desired to be, additional folding arms can be added to connect to points on the four edges of the screen to further stretch the screen 110. When properly tensioned the screen has concave edges. (See FIGS. 6 and 12 described later herein)

Further, the two arms on one side may be slightly longer than the two arms on the other side to compensate for the projector beam opening being off center to one side, and the weight of the screen and the shroud. Although other embodiments of folding collapsible arms may employ different arm arrangements or configurations that are collapsible. They unfold and extend out and tension the screen 110 when the ends of the arms connected to the housing 130 and the moveable member 140 are pushed towards each other by moving the sliding member 140 forward on the housing 130. Preferably each corner of the screen includes an attachment point(s) for the collapsible arms. Depending on how tensioned the screen is desired to be, additional collapsible folding arms may be added to the four corners or other edges of the screen using these clamps to further stretch the screen 110. Two such arms may be joined together to provide the required rigidity, stiffness, and strength for an arm member. Alternatively, the arm member may be constructed from a light weight but strong material, like fiberglass or carbon fiber or light weight but strong steel or other similar high strength metals. The arm needs to provide rigidity and strength without causing excessive weight.

Screen 110 may also have a foldable frame element that may be attached around its outer edge (not depicted) in a removable manner. This screen foldable frame element supports and provides tension to the screen to create a smooth projection surface. The screen foldable frame element can also easily collapse into a small size.

For rear projection, the material of the screen 110 is usually vinyl or silicone based translucent materials, although other similar elastic or flexible materials may be employed as a screen material. For the presently preferred silicone screens, small particles may be impregnated into the screen material for better luminance homogeneity.

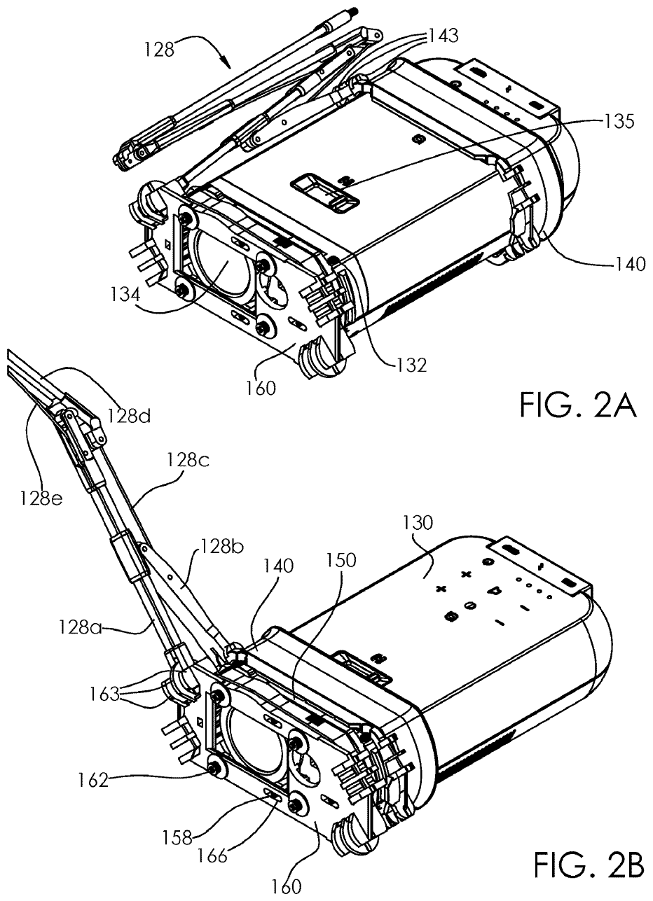

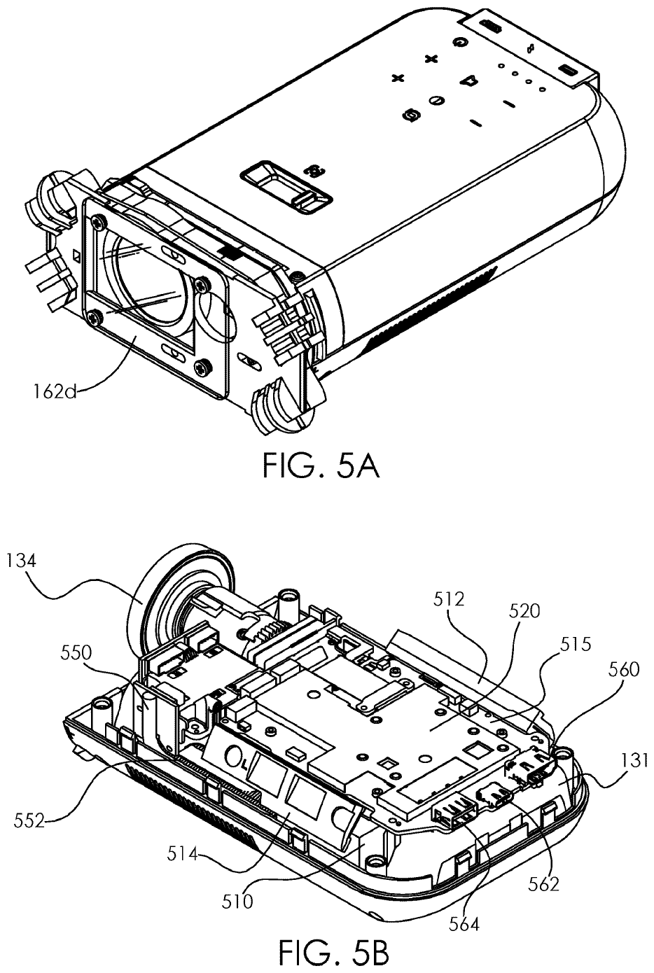

Continuing to refer to FIG. 1A, one embodiment of the Splay device 100 of the present disclosure, improves upon previous versions of a portable display device, such as that employed in U.S. Pat. No. 9,857,674. For such previous versions of a portable display device, one issue was that when the device was in the popped-up and extended position as shown in FIG. 2B, the arms are fixed in position relative to the main body or chassis member 130. However, during mass production of previous versions of the portable display device, each projector engine 134 (not shown in FIG. 1, but shown in FIG. 5B) had mechanical tolerances, and the image could shift sideways from the center of the screen 110, by shifting to different positions across the screen for different projector engines. (Discussed later herein regarding FIGS. 6A-6C) There were also other mechanical tolerances for previous versions of the portable display device, such as those of the arms, chassis 130, slider 140, etc. These various mechanical tolerances caused the final display device to have a non-centered image on screen 110, or even worse, a partially cutoff or cutoff image. FIG. 6A shows a centered image 112 on the screen 110, while FIG. 6B shows a shifted image 112 relative to the center of screen 110, and FIG. 6C shows a rotated image. A Splay embodiment of the present disclosure provides the ability to shift the image on the screen 110.

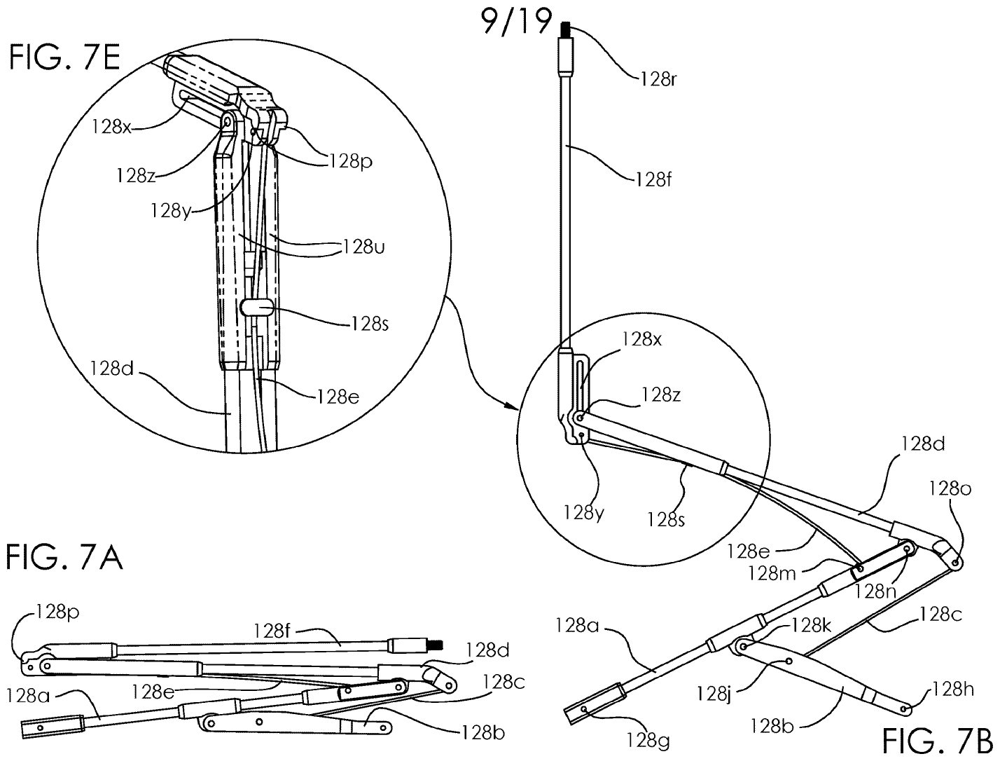

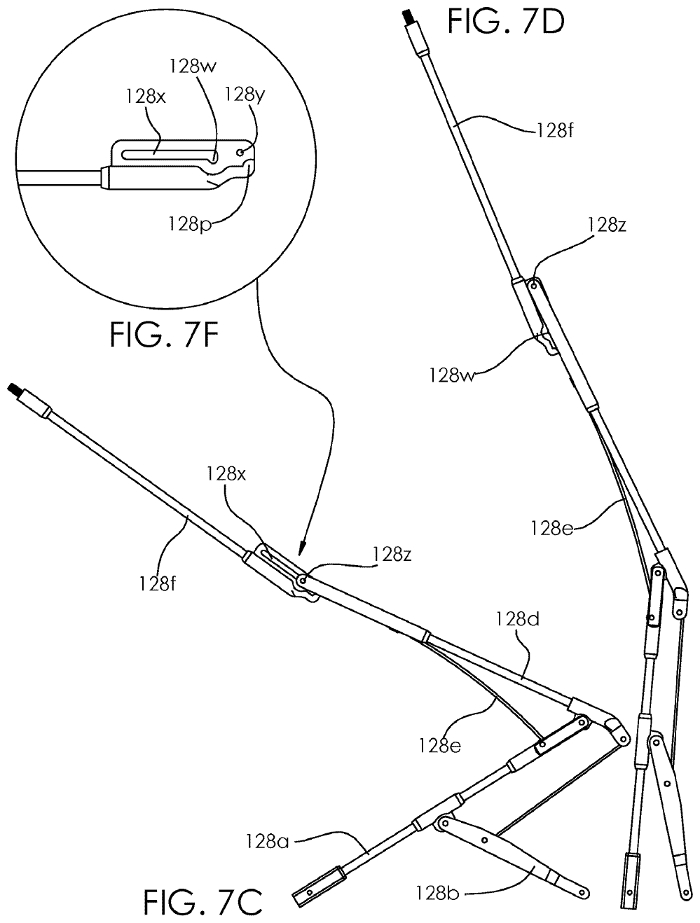

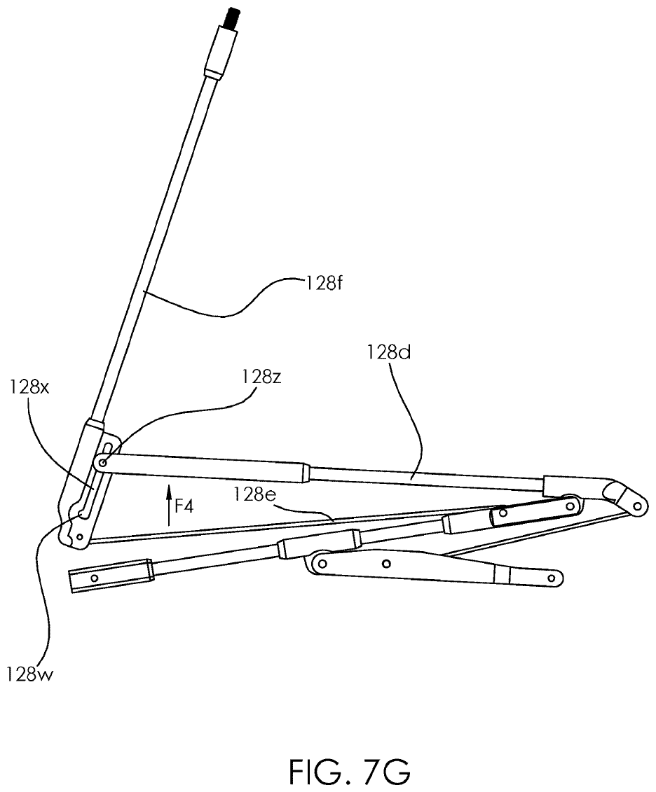

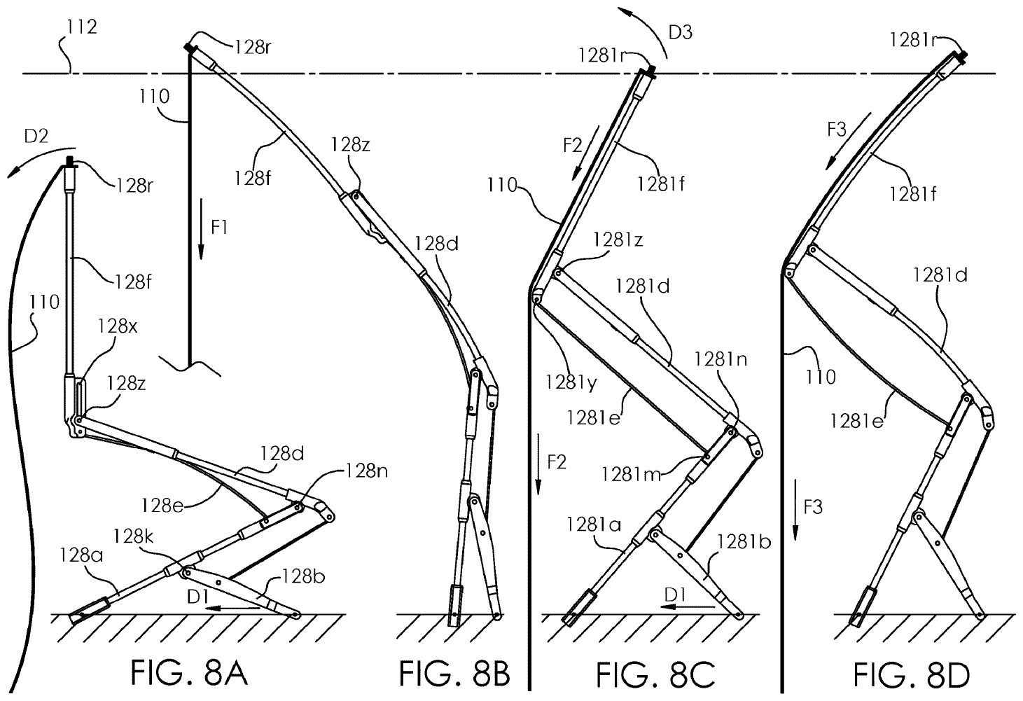

FIGS. 2A and 2B show the device 100 of FIGS. 1A and 1B. However, FIGS. 2A and 2B depict device 100 without the screen 110 and shroud 170 of FIG. 1. For ease of illustration purposes, this discussion deals with only one arm of the four illustrated in the Figures. Accordingly, FIG. 2 only show one representative arm 128 in a collapsed state in FIG. 2A and extended state in FIG. 2B. The segments (128a, 128b, 128c, 128d, and 128e) that make up each arm and their interconnections are best shown in FIG. 2B. It may be seen that each segment (except 128c and 128e) is composed of two parallel struts that are joined at either end by a strut holding extension to keep the two struts aligned and serve to provide openings for pivot point. Segments 128c and 128e are metal rods. Each of the struts is preferably made from extruded fiberglass and the strut holding extensions are preferably made of polyoxymethylene or polyformaldehyde (POM) plastic, or a similar structural plastic. A more detailed description of the arm segments, their interconnections and operation are described later herein, with regard to FIGS. 7 and 8. Although FIGS. 2, 7 and 8 show two struts for most segments, other embodiments may employ only a single strut, or more than two struts for each arm segment.

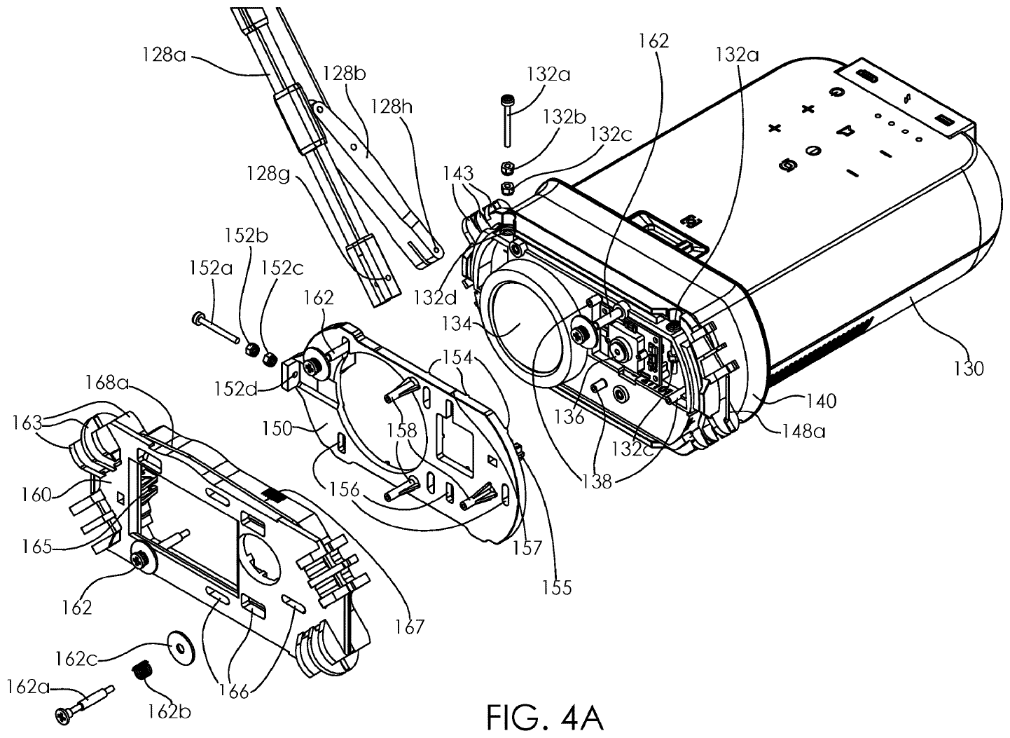

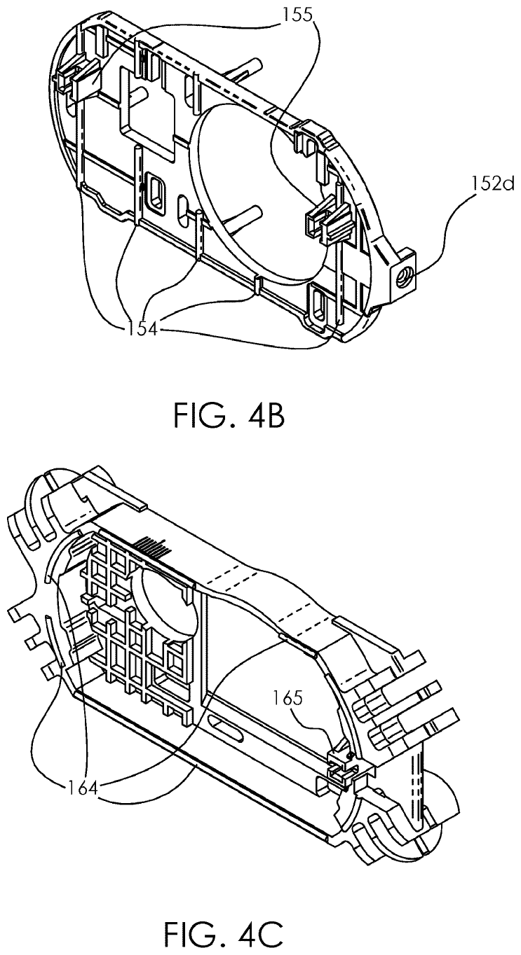

Again, for ease of illustration purposes, the following discussion deals with only one arm of the four illustrated in the Figures. As shown in FIG. 4A, arm 128 has two attachment points, one on the slider 140 through the three attachment point semicircles 143, and another one on the front plate 160 through three attachment point semicircles 163. There are currently no adjustment mechanisms on slider 140, so attachment point semicircles 143 stay stationary relative to the chassis 130 in the extended popped-up position. Referring now to FIG. 2B, to shift the arms in both the vertical and horizontal direction, the positions of mid plate 150 and front plate 160 of a translation assembly are employed to adjust the position of the attachment point semicircles 163. For example, if the image displayed on screen 110 is cut off at the bottom, by moving attachment point semicircles 163 downwards, arm linkage 128a moves downward while arm linkage 128b's attachment point semicircles 143 stays stationary, causing the whole arm 128 to rotate slightly downwards. The same movement applies to the four arms 122, 124, 126, and 128, and the screen 110 moves downwards relative to the projector engine 134 and results in centering the image on the screen. The same principle applies to when moving attachment point semicircles 163 horizontally.

FIG. 4A shows an exploded view of the translation assembly (or translation devices), or adjustment mechanism mentioned in the previous paragraph. Mid plate 150 is vertically adjustable relative to the main chassis member 130, and the front plate 160 is horizontally adjustable relative to the mid plate 150. Accordingly, front plate 160 is movable relative to the chassis 130 both vertically and horizontally, and thereby move the screen 110 relative to an image projected onto screen 110 by a projector (see FIG. 6).

Continuing to refer to FIG. 4A, mid plate 150 has vertical slots 156 (only three of seven are depicted and labeled) to fit through the pins 138 and screws 162 so that mid plate 150 does not misalign or move in the horizontal direction. To adjust the vertical position of 150 accurately, there are two adjustment screws 132a near the front left and front right of chassis 130. Screw 132a is rotatably secured onto chassis 130 by tightening a lock nut 132b on the other side of the hole 132d, through which the screw 132a goes. Another hex nut 132c is then added to screw 132a. Nut 132c connects to mid plate 150 through the holder 155. Holder 155 is essentially a slot in mid plate 150 with its width equal to the distance between the two parallel edges of the hex nut 132c, so that the hex nut 132c cannot rotate once positioned inside holder 155. Once installed, screws 132a may be operated to lower or raise the nut 132c, thereby lowering or raising the mid plate 150. To reduce the sliding friction, ribs 154 (or rails) are added to the back of the mid plate 150. When 150 moves relative to chassis 130, the ribs with small surface area slides smoothly against the front surface of 130.

FIGS. 4B and 4C show the back sides of mid plate 150 and front plate 160, respectively. These two Figures further show portions of these two plates that have been previously described and are further described hereinbelow. In more detail, ribs 154 and 164 may be made of slippery or slick plastics, like for example, but not limited to Teflon or polyoxymethylene or polyformaldehyde (POM) plastics.

Continuing to refer to FIG. 4A, front plate 160 has horizontal slots 166 (only three of seven are depicted and labeled) to fit through the pins 158 and screws 162 so that mid plate 150 does not misalign or move in the vertical direction. To adjust the vertical position of 160 accurately, there is one adjustment screw 152a on the left side of mid plate 150. Screw 152a is rotatably secured onto mid plate 150 by tightening a lock nut 152b on the other side of the hole 152d, through which the screw 152a goes. Another hex nut 152c is then added to screw 152a. Nut 152c connects to front plate 160 through the holder 165. Holder 165 is a slot similar to holder 155 so that the hex nut 152c cannot rotate inside holder 165. Once installed, screw 152a may be operated to move the nut 152c, thereby moving the front frame 160 to the left or right. There are also ribs (not shown) on the back of front frame 160, similar to ribs 154 to reduce sliding friction. When moving the front plate 160 relative to the mid plate 150, there are line markings 167 and 157 on the top to indicate the relative position between the front and mid plates, to assist in adjustment speed during mass production, if the same batch of devices has similar mechanical tolerances.

Once the mid plate 150 and front plate 160 is installed onto main chassis member 130, four set screw sets 162 keep the whole adjustment system in place. Each set of 162 consists of a screw 162a, a spring 162b, and a washer 162c. During installation, set screw 162a goes through both 160 and 150, and screws tightly into chassis 130. Spring 162b is in the compressed form during operation to provide sufficient pressure to prevent 150 and 160 from unintentional movement. Washer 162c serves as a base for the spring to rest on, as the spring cannot rest directly on the big open slot 166. A regular screw may also be used in place of the set screw 162; if a regular screw is employed it may need to be tightened on a regular basis. Adjusted too tight, 150 and 160 will have trouble sliding; adjusted too little/loose, they will likely move in an un-controlled manner during device operation. As shown in FIG. 5A, in one embodiment the four washers 162c that support the spring can be replaced by a transparent protective panel 162d. The panel can prevent the user from accidentally scratching the lens of projector engine 134. The material of the panel is preferably more scratch resistant than the lens material of projector 134, such as hardened glass. The panel is also preferably coated on both sides to increase transmittance and further harden the surface. The interior surface may be coated with industry standard anti-reflection coatings and the exterior surface may be coated with anti-abrasion materials.

Hex nuts 132c and 152c are preferably lock nuts so that there is some torque required when turning screws 132a and 152a, to allow for a more controllable and fine adjustment. Any other normal type of nut may also rotate undesirably due to the vibrations during use of the device. The added benefit of having two adjustment screws 132a is that one can not only move the mid plate 150 up and down, but can also rotate 150 slightly by setting the two nuts 132c at different heights, but within the tolerance of slots 156 and pin 138. The ability to rotate mid plate 150 slightly solves a potential manufacturing issue during mass production, when the image 112 on the screen 110 twists relative to the screen as shown in FIG. 6C, so that the image is not parallel to the edge of the screen 110. For a simpler alternative embodiment, only one set of adjustment screws may be used. Although screws and nuts are one embodiment illustration, the adjustment mechanism may also use worm gears, rack-and-pinion, or any other form of combinations.

In the embodiment of FIG. 4A, the three attachment point semicircles 143 stay stationary while three attachment point semicircles 163 move both horizontally and vertically. In other embodiments to achieve the same effect, the adjustment mechanism may employ any combination of three attachment point semicircles 143 and three attachment point semicircles 163. For example, the mid plate 150 may be hollowed and incorporated onto slider 140, making three attachment point semicircles 143 able to move vertically while three attachment point semicircles 163 are able to move horizontally. The movement direction of the mid plate 150 may also be interchanged with the front plate 160 by changing the direction of the set screws and slots, such that mid plate 150 moves horizontally while the front plate 160 moves vertically. A one plate embodiment may also be employed but may be less stable. By moving the horizontal adjustment mechanism 152 to chassis 130, combining front and mid plates into one plate, elongating hole 152d vertically, the new combination plate can move both vertically and horizontally. However, slots 156 and 166 will not be able to guide movement directions. For a one plate solution, a very robust, more expensive, and stable adjustment mechanism may be required.

Accordingly, it may be seen that the translation assembly comprises two abutting plates each having extensions for external rotatable and removeable connections and having openings for attachment to said housing/main member, and wherein each of said plates is moveable and adjustable in either a vertical or horizontal direction.

In FIG. 4A, device 136 is either a camera, IR sensor, or any other type of sensor that can enable touch screen, auto-focus of projector engine 136, or remote control. If device 136 enables auto-focus, the focus adjustment switch 135 (depicted in FIG. 2A and not labelled in 1C) will no longer be necessary. Both the mid plate 150 and the front plate 160 have openings through which device 136 may project. Device 136 may also be installed on 150 or 160 with a flexible cable connecting it back to chassis 130.

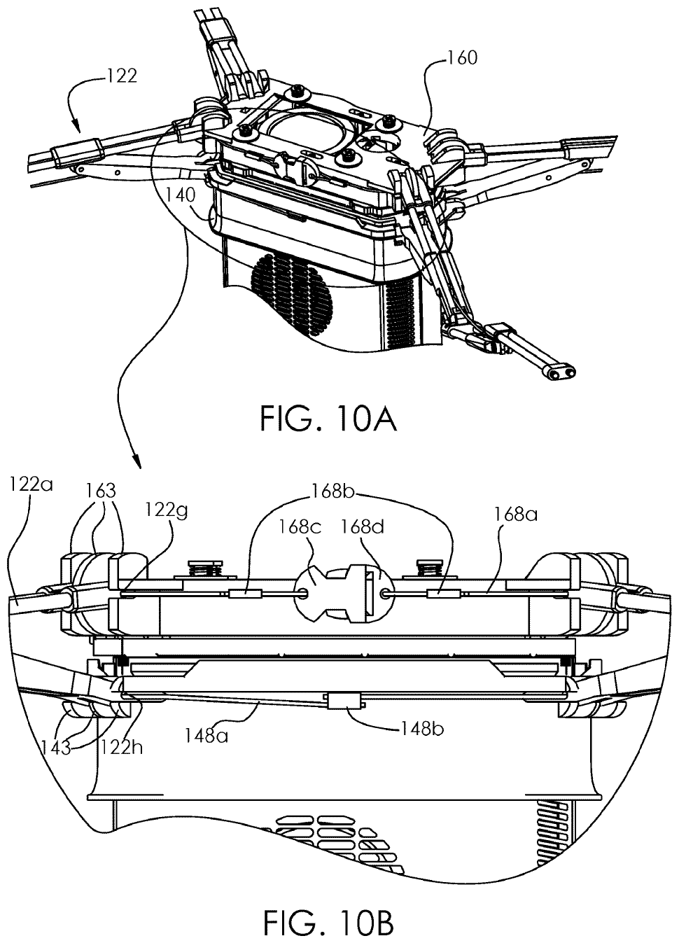

Referring now to FIG. 10B, there may be seen a cable 168 going around 160. Cable 168 goes through the slots in the semicircle holders 163 that holds the arms onto 160, which is mounted on main body 130. Similarly, cable 148 holds the arms onto slider 140. Other attachment structures may be employed for removably attaching the arms to the main body 130 and sliding member 140.

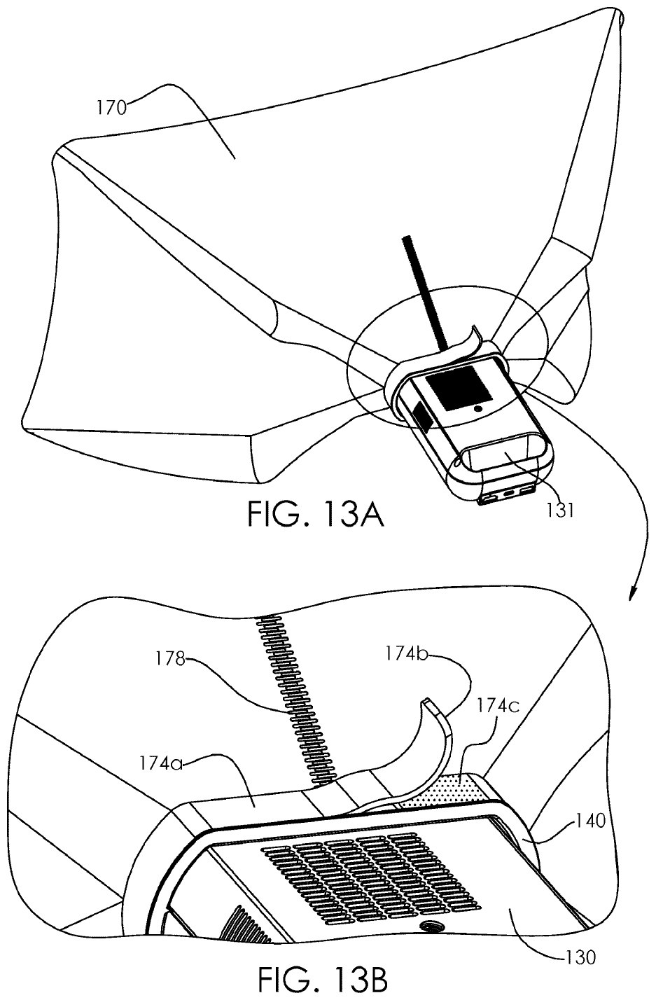

FIG. 13A illustrates an optional indented grip 131 on the back of the main housing member 130 The housing 130 may also include a handle instead of a grip at the very back of the device. The grip allows an individual to hold the device 100 while pushing the sliding member 140 forward and for conveniently carrying the device when fully collapsed.

The chassis or main housing member 130 may be configured to include a projector, or another form of a collapsible screen/display, in addition to mounting the multiple folding arms, and the exterior sliding member 140. Accordingly, for some embodiments, the housing 130 may hold any type of available, small, light-weight projector and its associated lens, provide support for the folding arms 122, 124, 126, 128, and allow the sliding member 140 to slide smoothly on the exterior of housing 130. Some embodiments may employ any projector that directly projects forward and does not use or have any mirrors, but other embodiments may use mirrors.

Referring now to FIG. 5B, there may be seen a partially, cut away top view of the internal components of the main body 130 of FIG. 4A. More particularly, there may be seen a printed circuit board (PCB) 515 for containing electrical components needed to operate projector engine 134. The PCB 515 may contain a microcontroller or microprocessor and associated memory for taking an HDMI signal and processing it to control projector settings, such as for example, but not limited to, brightness, vividness, contrast, image orientation, volume, etc. The PCB includes an operating system which employs a dropdown menu for selecting picture settings. The projector 134 in turn projects the image provided to it in an electronic format in a human comprehendible form for display on the screen 110. A lens assembly is used to focus the image on the screen and is typically a part of the projector engine. A battery 510 (partially depicted) is also located in the main body underneath the PCB 515. The battery serves to operate the projector when other sources of power are unavailable. The device 100 may employ a separate power device (not shown) for providing power to the device and for charging the battery, when needed, and uses a USB port (as noted herein below). The battery is preferably a lithium ion battery 510. The projector is preferably a commercially available DLP based projector engine, a LCOS projector, or a laser-based projector. The projector adjusts between projecting on the screen 110 when deployed and other surfaces when the screen is removed; such adjustment may be automatic or manual. As shown in FIG. 4A, in presently preferred embodiments, the projector is offset from the centerline of the body 130.

As noted earlier, for some embodiments the device 100 may employ a camera, preferably infrared sensing, (not depicted) for viewing the screen and the position of a finger or pointer on the image, and determining the location of that pointer on the image and then transmitting that to a controller to allow for a touch screen embodiment. Other touch screen embodiments may employ capacitive touch materials, or similar materials, in or on the screen. Other items shown in FIG. 5B include, but are not limited to, right and left speakers 512 and 514, respectively, heatsink pipe and fins 550 and 552, respectively, various interface ports for HDMI, USB-A and USB-C 560, 564, 562, respectively, and an ESD shield 520.

Referring now to the construction and operation of the arm segments and how they are interconnected, FIGS. 7A-7F and 8A-8D will be discussed. Again, in the following discussion, only one representative arm 128 and its many arm segments and their interconnections are shown and discussed, but the depictions and discussions are applicable to all four arms. FIG. 7A shown the arm segments of arm 128 in a collapsed state or condition, while FIG. 7B show the arm segments of arm 128 partially extended; both FIGS. 7A and 7B show the interconnections of the arm segments and their associated points of rotation. For representative arm 128, the arm segments are 128a, 128b, 128c, 128d, 128e, and 128f. In FIGS. 7A-7F and 8A-8D, the quadrilateral region formed between four interconnected arm segments of each arm that are associated with an interconnected rotational point (such as 128k and 128n) should be approximately in the shape of (or form) a parallelogram.

In more detail and referring now to FIG. 7B, for example, it may be seen that the polygon formed by rivets (or interconnection and rotational points) 128k-128j-128o-128n (that each form an interconnection and rotational point) is close to the shape of a parallelogram. Rivets are the presently preferred attachment between arm segments at points of rotation, but other attachments may be for example, but not limited to screws and locknuts, pins, etc. If the distance k-j (from rotational point 128k to rotational point 128j) is much larger than distance n-o (from rotational point 128n to rotational point 128o), then as the arm 128 extends and pops open (as rotational point 128h moves closer to rotational point 128g, or as arm segment 128b rotates about 128k towards arm segment 128a), distance n-o will rotate more degrees about rotational point 128n than distance k-j rotates about rotational point 128k.

Again, in more detail, assume the k-j is the distance from rotational point 128k to rotational point 128j, distance k-j=2*(n-o); where n-o is the distance from rotational point 128n to rotational point 128o. When distance k-j rotates about 128k clockwise for 10 degrees (0.175 radian), the distance that point 128j travels is 0.175*(k-j). Since arm segment 128c is rigid, it translates movement at a one-to-one ratio, moving point 128o the same distance 0.175*(k-j)=0.175*2*(n-o) clockwise. If the distance 0.175*2*(n-o) is divided by the radius of distance n-o, then point 128o rotates about point 128n for 0.175*2 radian, or 20 degrees, compared to 10 degrees by 128j. So, arm segment 128d flips open much faster than arm segment 128b can get close to arm segment 128a.

When arm segment 128d is at its most extended state (i.e., arm segment 128d rotating close to 180 degrees relative to rotation point 128o, then the end of arm segment 128c with rotational point 128o is hitting the arm segment 128a), arm segments 128a and 128b are nowhere near the end of their movement, or in the popped up or extended state. However, because arm segment 128d is already locked relative to arm segment 128a, and all the arm segments are interconnected, any further movement of arm segment 128b relative to arm segment 128a becomes impossible. Accordingly, arm segment 128 will be impossible to pop up now because its other interconnected arm segments do not get into their final position simultaneously, thereby hindering each other from moving further.

Accordingly, that is why the “polygon” needs to resemble the shape of a parallelogram so that arm segment 128d moves mostly parallel to arm segment 128b, and arm segment 128c moves mostly parallel to arm segment 128a; again, the quadrilateral region or “polygon” formed between four interconnected arm segments of each arm that are associated with a rotational point (such as 128k and 128n) should be approximately in the shape of (or form) a parallelogram. The shape doesn't need to be exactly a parallelogram because 1) each rivet connection has some slight mechanical tolerance; 2) each arm segment 128a, 128b, 128c and 128d is made out of steel wire or fiberglass and can have elasticity for minor deformations; 3) in the fully popped up position, rotational point 128h is still some distance away from rotational point 128g while arm segment 128d is close to be collinear with arm segment 128a, meaning that in the popped up position, arm segment 128b may only need to rotate 160 degrees while arm segment 128d needs to rotate 180 degrees. For an exact parallelogram, they would rotate same amount.

Continuing to refer to 7B, the same analysis may be applied to the area formed by rotation points (or rivets) 128m-128n-128z-128y. Again, the distance z-y needs to be similar to the distance m-n. It is desirable to have segment 128f (owns segment z-1) to flip open or extend much faster than 128a (owns segment m-n) extends. A method is needed to allow the rest of the arm segments to keep rotating, while segment 128f has already rotated close to 180 degrees to its final position early in the arm extension activity. This is achieved by making the distance z-y adjustable. In the first phase before arm segment 128f rotates to its final position, distance z-y is kept shorter than distance m-n so that it flips open (or extends) quickly, as shown from FIGS. 7A to 7C.

FIG. 7C shows the instant that the arm segment 128f flips to its full extended potential. Segment 128f flips to the full extended state when, as shown in FIG. 7E, the extrusion 128p hits the surface 128u of arm segment 128d, but this serves as a physical stop preventing it from rotating further. Normally, if rotation point 128z is a rivet, that would mean the 128m-128n-128z-128y polygon will be locked and unable to rotate more, but as seen in FIGS. 7E and 7F, rotation point 128z now slides in a slot 128x in arm segment 128f. So, rotation point 128z can not only rotate at point 128w but also slide in slot 128x. After the position in 7C, the rest of the arm segments keep on extending, and rotation point 128z starts to slide inside the slot 128x, effectively enlarging the distance z-y, making it closer to the distance m-n. In the design, the length of the slot 128x would be the extra distance rotation point 128m and arm segment 128e needs to rotate about rotation point 128n after arm segment 128f reaches its final extended position.

Groove 128w in FIG. 7F and the plate 128s in FIG. 7E holds down and deforms arm segment 128e. Groove 128w ensures the positions in FIGS. 7A through 7C, that rotation point and associated rod or pin 128z only rotates at one end of the slot and does not accidentally slide through slot 128x. The torque that rotates arm segment 128f comes from the pushing of 128e, which thanks to 128s pressing down, the direction of the pulling is along the direction of arm segment 128d, which in turn makes arm segment 128d push against the groove 128w, hence not allowing rotation point and associated rod or pin 128z to slip out into the slot 128x until the position shown in FIG. 7C. The plate 128s also assists in the process of collapsing the arm. Since the plate 128s presses down arm segment 128e, when collapsing, 128e pushes in the direction of the slot 128x so that rotational point 128z goes back into the groove 128w before starting its rotational action. Without 128s, 128f will start to rotate within the slot 128x and risk 128z never getting back into the groove 128w, hindering the next time the arm pops out.

FIG. 7G shows the same arm segments as the previous FIGS. 7A-7F, but without plate 128s, to show how plate 128s serves to keep 128e closer to 128d as noted in FIG. 7A, and how without plate 128s, pin 128z can stay in the slot 128x and not move into groove 128w. This results from force F4 pulling 128e closer to 128d as seen in FIG. 7A.

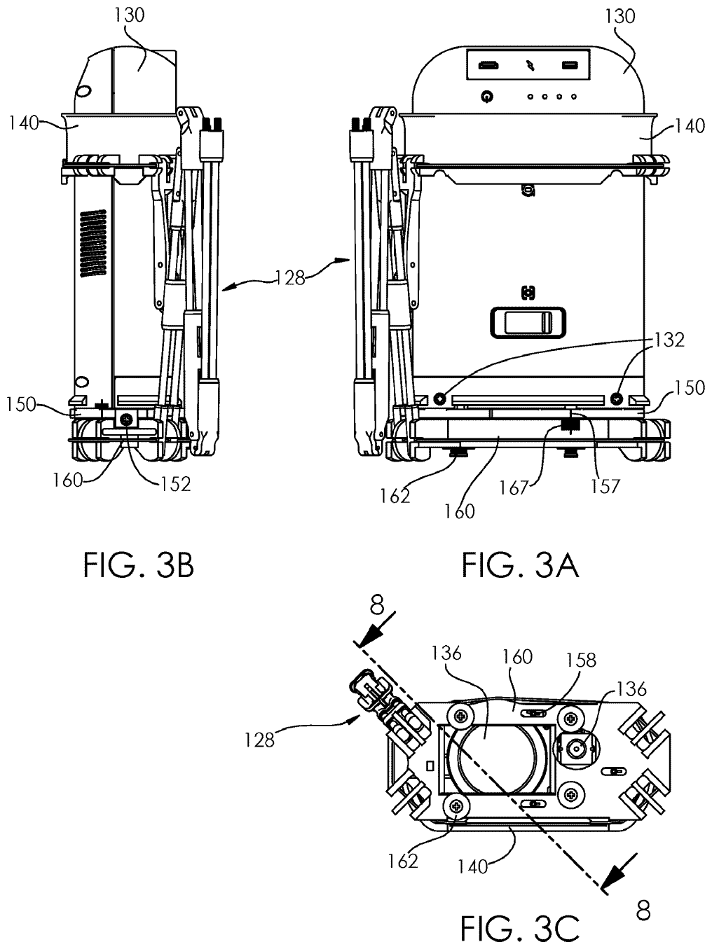

Arm segment 128f preferably flips out faster than the other attached arm segments. Referring to FIGS. 8A through 8D, which are diagonal cross sections of the unit shown in FIG. 3C, line 112 represents the threshold at which the tips of the arm segments have extended out far enough so that the screen has become tensioned. FIG. 8A shows the rotate-then-slide embodiment in which arm segment 128f flips out very early on (angle 128x-128z-128d>>angle 128d-128n-128a˜=angle 128n-128k-128b). When arm segment 128f is vertical to the ground, arm segment 128r is still below the 112 threshold, and screen 110 is not tensioned. By continuing to push the slider 140 (not shown) in the D1 direction, the tip of the arm will move freely in the D2 direction to the position in FIG. 8B. In FIG. 8B, tip 128r slightly extends beyond the line 112, and thus the arm tensions the screen 110 by stretching it beyond line 112 a little bit. Because of the tension F1, arm segments 128f and 128d are both bent a little bit, forming a continuous curve. FIGS. 8C and 8D show the same arm segments as the previous FIGS. 7A-7G but respective items are labelled 128# (where # represents each equivalent item label for the previous FIGS. 7), but without plate 128s. In FIG. 8C, an embodiment where arm segment 1281f flips open at the same rate as the other segments is shown. Before arm segment 1281f can reach the vertical location by moving arm segment 1281b in the D1 direction, the tip 1281r already hits the threshold 112, and tension F2 starts to accumulate in the screen 110. To overcome the vertical location and arrive in the state of 8B, the tip 1281r needs to move in the direction of D3. However, tension F2 goes in the opposite direction of D2, preventing the motion in the direction of D2. FIG. 8D shows what happens to the arm embodiment illustrated in 8C if the arm segment 1281b is pushed in the D1 direction. Movement of slide 140 keeps pushing arm segment 1281b in the D1 direction and the tension keeps getting larger (F3>F2), thus forcing the arm segments 1281f, 1281d, and 1281e to bend prematurely, resulting in the shape in FIG. 8D. The embodiment in FIG. 8D will never be able to reach the shape and configuration of FIG. 8B.

Accordingly, it may be seen that each of the multiple collapsible arm members are made up of several sequentially interconnected and linked arm segments. In more detail, each of said collapsible arm members comprises, a first main strut member rotatably and removably attached at a first end to a point attached to said housing member and at the opposite second end rotatably interconnected to a second main strut member at a point offset from a first end of said second main strut member, wherein said second main strut member is at a second end opposite from the interconnection to said first main strut member interconnected to a third main strut member at a moveable point offset from a first end of said third main strut member, a first supporting strut rod member rotatably interconnected/attached to the first end of said third main strut member and rotatably interconnected/attached to said first main strut member at a point offset from said second end of said first main strut member and restrained from separating from said second main strut member near the second end of said second main strut member, a first activating strut member rotatably and removably attached at a first end to a point attached to said sliding member and rotatably interconnected/attached to said first main strut member at a point adjacent to at the approximate midpoint of said first main strut member, and a second supporting strut rod member rotatably interconnected/attached to said first activating strut member at said first end of said second main strut member and rotatably interconnected/attached to a point adjacent the second end of said first activating strut member.

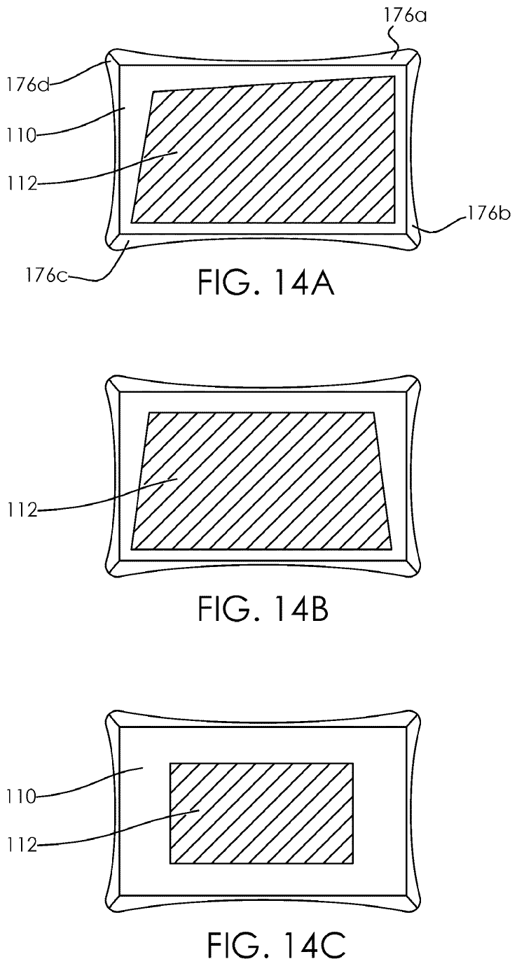

In addition, the end of each third main support member (represented by 128 in FIGS. 7A-7G and 8A-8D) is shown in 7B as ending in end in a means 128r for releasably connecting to a screen 110. The details of this releasable connection means is described in more detail later herein, with regard to FIGS. 14A-C and 15A-B. Although the releasable connection means is described as being at the end of each third main support member, such releasable connection means may be employed in other locations and other members in other embodiments of the present disclosure.

FIGS. 9A and 9B illustrate how the arms on the left side of the unit have different section lengths from the ones on the right side of device 100.

In more detail, FIG. 9A shows the front view of the unit when screen 110 and shroud 170 is not installed yet (arms are extended but not tensioned like in FIG. 8B). Projector engine 134 is offset to the left from the center of the unit 100. This intentional offset is different from the unwanted tolerance issues for which the adjustment mechanism was created to resolve. The intentional offset may be caused by 1) an asymmetry in the projector engine 134 shape; 2) an asymmetry in the internal electronics layout; 3) the requirement that the electronics to be arranged in an offset manner, etc. The degree of the intentional offset can easily exceed the range of the minor adjustment mechanism targeted towards relatively small mechanical tolerances. To compensate for the offset, the configuration of the arm segments on the left (128 and 122) may be different from the arm segments on the right (126 and 124). In the embodiment in 9A, the projector is offset to the left, and hence the arms on the left extend farther out than those on the right side.

FIG. 9B shows a side by side comparison of one arm on the left 128 and one arm on the right 126 in their collapsed state. One can see that the points of rotation or holes of 128g, 128k, and 128h are aligned so that during the popping up process, both arms still travel the same distance to be able to fit onto one slider 140 together. However, the length of arm member 128a differs significantly so that the arm segment 128a on the left has a longer arm segment 128a to extend further out. The length of the other arm segments is also adjusted accordingly to achieve similar tension in the left and right arms, so that when tensioning screen 110, the tension force is even. If the tension force is not even across a huge span of soft elastic material (screen 110), then tension lines and creases can easily appear.

Referring now to FIGS. 14A-14C, there may be seen a first representative distorted image 112, a second representative distorted image 112, and a third representative distorted image 112, respectively.

In more detail, FIGS. 14A-14C each represent images 112 on screen 110 that result from the distance from the corner of a screen to a projector being different for the arms 124, 126, 128, 130 that may result from manufacturing tolerances during assembly of different embodiments of the present disclosure.

FIG. 14A shows a projected image 112 that has top left corner closer to the projector than the other three corners. Portions (176a-d) of the shroud 170 are also show in this Figure, as noted later herein. FIG. 14B shows a projected image 112 that has both top corners closer to the projector than the lower two corners. FIG. 14C shows a projected image 112 that has the correct rectangular shape, but the whole image is too small. These images may be corrected to display the correctly sized and shaped image by adjusting the distance between the corners of the screen and the projector by adjusting the length of each arm, by employing a releasable connection means 128r.

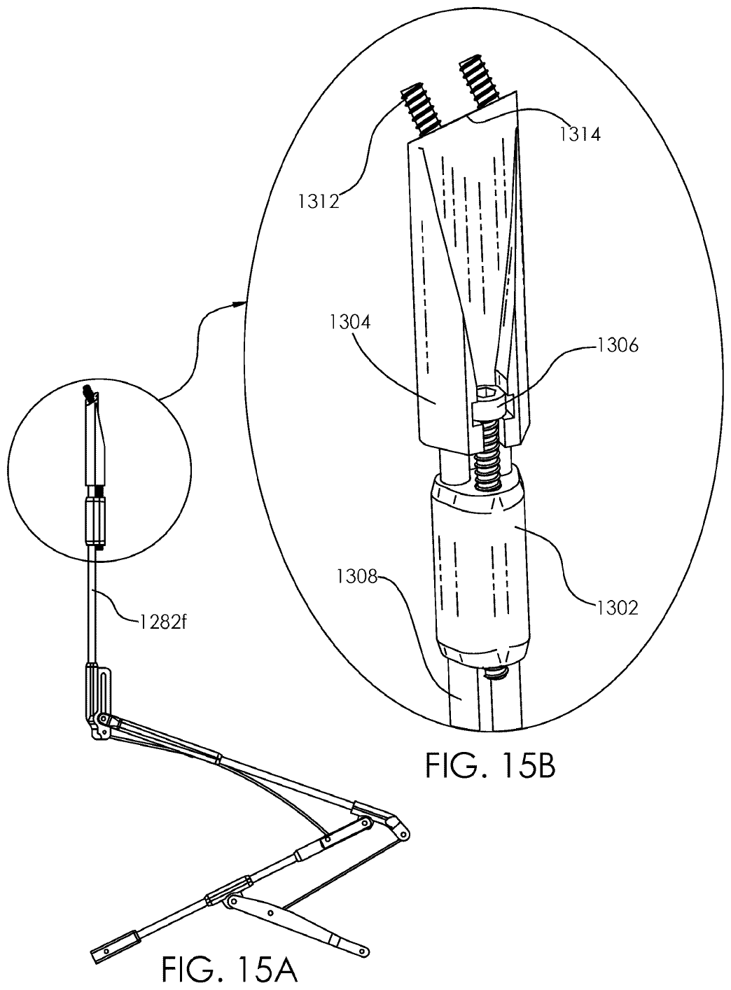

FIGS. 15A-B show the details of this releasable connection means 128r employed at the end of each arm, represented by arm 128, in FIGS. 7A-G, and 8A-D. Although depicted in these and other Figures as having two ends, or screws, and two associated openings in 116a of a representative screen mounting assembly on screen 110 (as shown in FIG. 12B), clearly other configurations using one or more such ends and equivalent openings in screen attachment assemblies is contemplated by the current disclosure.

Referring now to FIG. 15A, there may be seen another depiction 1282 of the original arm 128 in FIG. 7B. Arm 1282 shows that arm member 1282f has a means for releasably attaching to screen 110.

FIG. 15B is an enlarged view of a portion of arm member 1282f showing one embodiment of a releasably attaching means 128r. Continuing to refer to FIG. 15B, there may be seen two preferably fiber glass rods 1308 of arm member 1282f, which are the same rods employed in arms 122, 124, 126 and 128, as depicted earlier herein. Base 1302 is injection molded onto the two fiberglass rods 1308 and is fixed in place to rods 1308. Base 1302 has a threaded opening or through hole aligned with the direction of rods 1308.

Adjustment screw 1306 is contained in this opening and moves up and down in this threaded opening by turning the screw. Socket assembly 1304 has two openings in its base to accept the ends of rods 1308 extending beyond base 1302, that allow socket 1304 to slide along the ends of rods 1308. Movement of socket assembly 1304 along the ends of rods 1308 allows for adjustment of the distance between a corner of the screen and the projector to adjust for images like those in FIGS. 14A-C.

Continuing to refer to FIG. 15B, there may be seen two screw extensions 1312 that attach the ends of each arm to the screen. As noted earlier herein, although two such screws are presently preferred, one or more such attachment items may be employed in embodiments of the present disclosure. Also, note that the top surface 1314 in contact with the screen is slightly tilted to tension the screen in a flat manner that is perpendicular to the projector beam, resulting in a flat screen for depicting images.

Continuing to refer to FIG. 15B, the screw 1306 is rotatably located in a fixed position in socket 1304, such that rotating screw 1306 adjust the position of socket assembly 1304 to extend or shorten the length of an arm 122, 124, 126, or 128, and correct images like those in FIGS. 14A-C. Although not depicted in FIG. 15B, a retaining member may be placed around socket assembly 1304 near the top of screw 1306 to prevent screw 1306 from accidently popping out of its rotatable position and opening in socket assembly 1304 when being rotated.

The device shown in FIG. 1A is usually used as a collapsible display device with a built-in projector engine. To make this device even more versatile, the device may also be used as a normal projector once the arms, screen 110 and the shroud 170 are removed. The bottom side of the shroud has a zipper 178 (depicted in FIGS. 13A and 13B) that allows the shroud to be unzipped and expose the arms and structures like the projector 134 and front plate 160. The shroud may be kept on the arms during the removal process, but for simplicity of depiction purposes, the drawings only show the arms without the shroud. FIG. 10B is an enlarged overview of a portion of FIG. 10A.

FIG. 10B includes two methods to attach the arms to the body. The first way is permanent. Arm segment 122b is rotatably attached to slider 140 via the cable 148a. 148a goes through the hole 122h on arm segment 122b, and locks arm segment 128b into the attachment point slots 143. Cable 148a sequentially goes through all the other three pairs of arms. The two ends of the cable are then crimped together through a ferrule crimp 148b. Of course, any type of permanent connection may work, such as tying the cable together. Removal of cable 148a allows for removal of the arms from slider 140. The cable material may be nylon, steel, or any other strong material.

The second method is removable. Arm segment 122a is rotatably attached to front plate 160 via the cable 168a. 168a goes through the hole 122g on arm segment 122a, and locks arm segment 128a into the attachment point slots 163. Cable 168a sequentially goes through all the other three pairs of arms. Instead of one ferrule connecting the two ends of the cable, the two ends are attached to a buckle (female 168c, and male 168d) that can easily lock or unlock. The cable is connected to the buckle through two ferrules 168b.

After unlocking the buckle 168, the slider 140 may be moved backwards (direction D4 in FIG. 11) out of the chassis 130, resulting in the state shown in FIG. 11 (Shroud 170 is not shown covering the arms in FIG. 11).

In more detail, there may be seen an example of a prototype of the screen 110, for a representative portable display device 100, in the extended and tensioned popped-up or operating position FIGS. 6 and 12B. Although the screen 110 is preferably in a rectangular form factor as depicted, other form factors, such as, but not limited to, a square may be employed. For this example, the screen and its skirt member around the edges of the screen are also seen. However, use of a skirt is optional. When used, the skirt may consist of cloth with Velcro around the outermost edges for an optional attachment to the shroud. As depicted in FIGS. 6, the screen 110 may have concave edges to prevent screen wrinkling when deployed and properly tensioned.

Referring now to FIG. 12A, the screen material shown in most of the area has a thickness preferred to be below 1.0 mm and greater than 0.1 mm to achieve good light transmittance while not tearing easily. Referring to FIG. 12B, though the screen can be one flat piece, it is preferred to have markings 114a and 114b on it to assist in the process of sewing or gluing with the shroud 170's fabric pieces. The triangles 114a assists in the process of aligning fabric pieces, and also in the process of applying tape 118 if gluing is chosen over sewing. For instance, the triangle at the bottom right corresponds to the center-point of the right side edge of the screen, and the corresponding fabric piece 176b (FIG. 6A) may be easily aligned to the right edge, especially when the inside of 176b has a chalk marking or small cut. FIG. 6A shows the front view when the screen is attached to the shroud, and the 4 pieces of shroud fabric 176a, 176b, 176c, and 176d may be seen. Each shroud can either be formed with 4 pieces of fabric or 8 pieces, depending on whether the pieces are cut out separately. The diagonal seams are shown where the four pieces of fabric are sewn together at each corner. Note that where the pieces are sewn together, there may be pockets or loops that contain the arm segments (FIG. 1C shows a X-ray view of a portion of a collapsible arm member in such a pocket).

Referring now to FIG. 12B, the reference line 114b is shown. This line also assists in aligning the fabric piece edge to be flat against the line, and also serves as a straight line reference when applying tape 118. The screen also has corner 116a. The arms connect to 116a through the holes on 116a. The tip of the arm 128r (as shown in FIGS. 7A-7D and labelled in FIG. 7B) is threaded, and it goes through the holes and a nut on the other side will secure the screen on the tip. 116a is the piece that connects to the arms, and thus it is the point where tension is the greatest. The corner 116a can be made much thicker than the average screen thickness in order to be stronger, such as 3.0 mm or thicker. Or the corner tab may be made out of a different material, such as a more rigid rubber with higher hardness, or even be rubber encapsulating a metal piece inside to be completely rigid. On the outermost frame of the screen, a ring of strengthening ribs 116b (that is also thicker like 116a) may optionally be employed to further prevent tearing from the edge.

The material of the screen 110 is usually vinyl or silicone based translucent materials that are mixed and then injection molded, although other similar elastic or flexible materials may be employed as a screen material. Preferably, the present screen material is formed from a base silicone rubber in a stirring mixer or through a roller; the liquid silicone rubber is mixed as one part and any dye and diffusion particles are mixed as a second part, and these two parts are equally mixed in the barrel of an injection machine and then injection molded into a screen. These materials diffuse the light coming from a projector, resist wrinkles when stored fold-up, and are stretchable to a tensioned state for display. For a front projection embodiment, the material of the screen would no longer be translucent but solid, while still possessing the other features of the rear projection screen material.

For the presently preferred silicone screens, small dispersive particles may be impregnated into the screen material for better luminance homogeneity. These particles preferably refract light differently than the actual screen material. The particles may be made out of, for example, small titanium dioxide particles or silicone. The particles are generally less than 10 microns in size. These particles may be added to the screen material in an organized and aligned pattern to improve image quality.

In addition to the particles to improve homogeneity, other substances such as particles with different colors, a colored paste, and a dye may be added to the screen material. These substances will further improve screen quality. For example, colored particles may be used to make the screen grey to achieve a higher contrast for projected images.

Further, although not presently preferred, a screen may be made up of several different layers. Each layer may be rubber or silicone rubber to improve the wrinkle resistance property, or can be materials with different optical features, such as, but not limited to, a layer made out of plastic substrate containing optical enhancing component(s) (glass or plastic micro-lenses, and micro-structures, etc.), a layer made out of rubber substrate containing compound light dispersing particles or coatings, or a layer with other optical processing materials or optical enhancing components. The use of these various optical enhancing components in the screen materials improves the image clarity and quality for better viewing.

In addition, other features may be added to the screen material in addition to or in place of the embedded particles; such features may be for example, but not limited to, Fresnel lens(es), micro-lenses, color filters, quantum dots, nano-dots, or other micro-structures that absorb light coming from the top or outside (sun light and/or room light). Further, the screen may be made up of several different wrinkle-resistant rubber or silicone rubber layers, and layers containing materials with different optical features, such as for example, but not limited to tear resistant materials, containing micro-lenses or micro-structures, light dispersing particles or coatings, or other optical processing materials or optical enhancing components. The use of these various optical enhancing components in the screen materials improves the image clarity and quality for better viewing.

Quantum dots would, specifically, enable light transmission to be tuned to the specific wavelength range of the, three or more, LEDs (or lasers) often used in micro-display based projector devices or the wavelengths of the LEDs can be modified to be best suited for the quantum dots. Coupled with a dark base material or a dark layer facing the unwanted light, the quantum dots would reject the vast majority of ambient light, drastically increasing display contrast. In this way, light transmission may be optimized for the three, or more, LED wavelength ranges and the light outside of these bands may be rejected, drastically increasing projected display contrast.

Also, the projector illumination LEDs may be UV LEDs to be sensitive to the current most widely available quantum dots that are sensitive to UV light and transmit visible light in response to the correct incident wavelength UV light. Alternatively, color filters may be placed in the screen that only transmit the wavelength of the three, or more, LEDs. Also, the display illumination LEDs may be UV LEDs to be sensitive to the current most widely available quantum dots that are sensitive to UV light and respond with the emission of visible light.

These presently preferred screen materials diffuse the light coming from a projector, resist wrinkles when stored folded, and are stretchable to a tensioned, wrinkle-free state. The screen may also be dust-resistant, may be easily cleaned with soap, and is durable. For front projection, the material of the screen would no longer be translucent but reflective.

Some of the screen material selections may be prone to tear caused by existing cuts and holes, such as silicone rubber material, for which a cut can propagate easily. To prevent a tear or cut from propagating on a single sheet of silicone rubber as the screen material, another layer of silicone rubber may be place onto and over the existing cut, using Room-Temperature-Vulcanizing silicone (RTV) as the gluing agent, or any other applicable glue. An example of the method on the current embodiment would be to place/attach silicone rubber pads on top of the threads and holes caused by attaching a screen to a shroud for a rear view screen. Other solutions to the potential tear problem may include, but are not limited to, the aforementioned method of multi-layering by layering the screen material with tear-resistant materials.

Accordingly, one embodiment of the present disclosure is a portable, collapsible screen, containing an elastic or flexible/stretchable material containing embedded particles of at least one of the following: quantum dots, color filters, and other microstructures as an optical enhancing component suitable for displaying images clearly and mitigating wrinkles when properly tensioned for display.

Accordingly, an additional embodiment of the present disclosure is a collapsible screen, containing a translucent main layer and a thin second layer on the outside surface of the screen that is painted darker, so that when light (of the projector) passes through the translucent volume of the screen from behind, its radiant flux is not significantly reduced, while ambient light is absorbed by the outside darker surface, thereby achieving higher brightness and better contrast for the displayed image.

Accordingly, an additional embodiment of the present disclosure is a collapsible display screen, consisting of a translucent thin layer of injection molded silicone rubber mixed with particles as part of the injection molding process, and wherein said particles include at least one of the following: quantum dots, color filters, nano particles, and other microstructures as optical enhancing components for displaying images clearly.

Accordingly, a presently preferred embodiment is a portable display device with a collapsible screen or display containing a portable projector device in the main housing member with a sliding member aligned on the exterior of said main housing for sliding along the exterior of said main housing between two operating positions, and includes multiple collapsible arm members connected to both said sliding member and said housing member and connected to a collapsible screen for displaying an image when deployed, and for moving said collapsible screen between a first open deployed position for display and a second collapsed position for storage, and said screen is removable.

In FIG. 13A, a grip 131 at the bottom of the device 100 is shown. This grip is for the user to grab with one hand while the other hand pushes the slider 140 forward. The handle allows the device to be expanded and collapsed ease.

As shown in FIG. 13B, the shroud has a zipper 178 that allows the user to open it and remove the arms and shroud, enabling the device to be used as a normal wall projector without a collapsible screen. When the zipper is closed, the head of the zipper is hidden below the fabric band 174a and above slider 140. Fabric band 174a is sewn to the shroud fabric and wraps around slider 140. The fabric band connects to itself via a Velcro strip 174b and 174c. The band 174a preferably has a silicone coating or rough surface on it, so that when the user grips the fabric band/the slider, it is hard for the user's hand to slip when pushing the slider. The Velcro may be replaced with any type of fastening mechanism such as a button.

Preferably, the screen 110 is glued to the fabric material of the shroud 170 using pieces of tape, although for example, but not limited to, the fabric and screen material may be elastically sewn together. The connection between the screen and the shroud needs to retain its stretchability after gluing with tape, or else the tension stemming from the four corners of the screen will not distribute evenly. The tape preferably employs a glue that will adhere to and stretch with the screen material, but needs to adhere tightly with both the screen and shroud for durability purposes. If the tape does not glue tightly enough then a pre-finish treatment of the surfaces using chemicals may be needed.

Turning now to the shroud, as shown in FIG. 1A, the back of the embodiment 100 includes a shroud 170 that shapes like an “X”, with each tip of the “X” being a sleeve pocket (172a, b, c, and d) that includes an arm member. The purpose of the “X” design is two-fold. First, it reduces the cone volume of the shroud when popped up. The smaller the volume the shroud occupies, the smaller and more compact the whole unit will appear. The second reason is to constrain the arm segments. The shroud is preferably made from a dark flexible, wrinkle resistant fabric.

The arm segments need to be attached to the shroud in the corner they each belong to, as well other attachment points. Otherwise when the unit is collapsed, the fabric of the shroud can move around, and could potentially tangle the fabric with the arms, thereby preventing a smooth pop-up for the next use time. Traditionally, in umbrellas, to keep the fabric in place, a common strategy is to use crimps or needle and thread to fix the arm on the fabric, which can be time consuming. By having a sleeve like 172d, each of the multiple collapsible arms may “slip” into the shroud and not move around too much, with no additional sewing or crimping.

Referring to FIG. 1C, a portion of arm 128 inside sleeve 172d (only a portion of the arm is shown) is shown. To create the sleeve on the template, line 171 will need to be sewn together while leaving the other parts open forming a sleeve or open loops which contain arm segments so that the arm will have sufficient movement space yet not moving around too much.

For a presently preferred prototype embodiment the body is approximately 4⅓ inches wide, 7½ inches long, and 2 1/10 inches thick and employs three lithium ion cells in series for the battery to obtain approximately 11.1 volts. The longest strut of an arm for this embodiment is approximately 150 mm. When the screen is deployed (or popped up) the dimensions are approximately 520 by 360 by 610 mm.

One type of screen is a front view screen, where the screen and the projector and the viewer are all on the same side of the screen. The other type of screen is a rear view screen, where the projector projects images onto one side of the screen and the viewer is on the other side of the screen from the projector. The screen of the present disclosure may be employed as either a front or rear type of screen. As one embodiment, the screen is used as a rear screen for a portable display device described more fully later herein.

While the present disclosure has been described with respect to the embodiments set forth above, the present disclosure is not necessarily limited to these embodiments. Accordingly, other embodiments, variations, and improvements not described herein are not excluded from the scope of the present disclosure. Such variations include but are not limited to new screen material, new screen particulate material, new lenses and/or mirrors, and new projectors.

Although the present disclosure and its advantages have been described in detail, it should be understood that various changes, substitutions and alterations can be made herein without departing from the spirit and scope of the disclosure as defined by the appended claims.

What is claimed is:

1. A portable display device with an attached collapsible and removeable screen, comprising:
a housing member containing a projector and associated display lenses,
a screen capable of displaying an image projected by said projector when deployed,
a sliding member aligned on the exterior of said housing member for sliding along the exterior of said housing member between two operating positions and off the housing member when removing said screen, and
multiple collapsible arm members fixedly and adjustably connected to said screen and rotatably connected to both said housing member and said sliding member for moving said screen between a first and second position,
a translation assembly to which a first set of said multiple collapsible arm members are rotatably and removably connected, and
wherein said translation assembly adjusts the position of a projected image from said projector on said deployed screen.

2. The portable display device of claim 1, wherein each of said collapsible arm members comprises:
a first main strut member rotatably and removably attached at a first end to a point attached to said housing member and at the opposite second end rotatably interconnected to a second main strut member at a point offset from a first end of said second main strut member,
wherein said second main strut member is at a second end opposite from the interconnection to said first main strut member interconnected to a third main strut member at a moveable point offset from a first end of said third main strut member,
a first supporting strut rod member rotatably interconnected/attached to the first end of said third main strut member and rotatably interconnected/attached to said first main strut member at a point offset from said second end of said first main strut member and restrained from separating from said second main strut member near the second end of said second main strut member,
a first activating strut member rotatably and removably attached at a first end to a point attached to said sliding member and rotatably interconnected/attached to said first main strut member at a point adjacent to at the approximate midpoint of said first main strut member,
a second supporting strut rod member rotatably interconnected/attached to said first activating strut member at said first end of said second main strut member and rotatably interconnected/attached to a point adjacent the second end of said first activating strut member.

3. The portable display device of claim 2, wherein the releasable connection means of each of said arm members comprises a socket assembly slidably positioned on the end of each arm for releasably connecting with said screen and adjusting the overall length of each arm.

4. The portable display device of claim 3, wherein the releasable connection means of each of said arm members further comprises a base member fixed on said arm near the end of each of said arms for adjustably connecting to said socket assembly.

5. The portable display device of claim 4, wherein the releasable connection means of each of said socket assemblies comprises a releasable interconnection assembly and having a flat surface angled to connect to said screen in a manner to provide a deployed screen perpendicular to a projector beam.

6. A screen mounting assembly, comprising:
a rod member for supporting said screen and removably attaching to said screen,
a base member fixedly attached near the end of said rod for connecting to said screen,
a socket assembly slidably positioned on the end of the said rod member adjacent said base member and configured to releasably attach to said screen, and
an adjustment member positioned between said base member and said socket assembly operably interconnected to both said base member and said socket assembly for adjusting the distance between said base member and said socket assembly to adjust the positioning of said screen.

7. The portable display device of claim 1, further comprising:
a flexible, wrinkle-resistant shroud member attached to said screen and removably attached to said housing member and having a pocket for containing each of said multiple collapsible arm members for blocking external light from said screen when said screen is deployed.

8. The portable display device of claim 1, wherein said translation assembly comprises: two abutting plates each having extensions for external rotatable and removeable connections and having openings for attachment to said housing/main member, and wherein each of said plates is moveable and adjustable in either a vertical or horizontal direction.

9. A portable display device with a removeable screen, comprising:
a housing member containing a projector and associated display lenses and having a sliding member aligned on the exterior of said housing member for sliding along the exterior of said housing member between two operating positions,
a screen capable of displaying an image projected by said projector when deployed, and
multiple collapsible arm members removably connected to said screen and rotatably and removably connected to both said housing member and said sliding member for moving said screen between a collapsed and deployed position in functional relationship with the position of the sliding member on the housing member,
wherein a first set of said multiple collapsible arm members connected to said housing member are rotatably and removably connected to a translation assembly located on one of said housing member and said sliding member,
wherein said translation assembly adjusts the position of a projected image from said projector on said deployed screen, wherein a second set of said multiple collapsible arm members are rotatably and removably connected to said sliding member, and
a flexible, wrinkle resistant shroud attached to said screen, having sleeves for containing said arm members and removably attached to said housing member.

10. The portable display device of claim 1, wherein said sliding member and said multiple arm members are removed from said housing member along with said screen and shroud.

11. The portable display device of claim 9, wherein each of said arm members comprises a plurality of operably interconnected segments that collapse in a nested arrangement and collectively extend into an articulated load bearing member for tensioning said screen in functional relationship with the position of the sliding member on the housing member.

12. The portable display device of claim 9, wherein said screen collapses around said housing member, said multiple collapsible arm members and said sliding member.

13. The portable display device of claim 2, wherein each of said main strut members and said activating strut member comprises at least two structural members.

14. The portable display device of claim 13, wherein each of said main strut members and said activating strut member comprises a rigid attachment member at each end of said at least two structural members to hold them in a parallel position and provide openings for rotatable interconnections.

15. The portable display device of claim 1, wherein said screen in a collapsed state encloses said housing member, said sliding member and said multiple collapsible arm members.

16. The portable display device of claim 1, wherein said screen is configured to be a touch screen.

17. The portable display device of claim 1, wherein said screen has concave edges when properly tensioned and deployed.

18. The portable display device of claim 1, wherein said screen contains embedded optical enhancing components and particulates.

19. The portable display device of claim 9, wherein said first set of said multiple collapsible arm members and said shroud are detached from said housing member and said sliding member is removed from said housing member along with said multiple collapsible arm members, said screen and said shroud.

20. A portable, collapsible screen, comprising:
an elastic or flexible material containing embedded particles of at least one of the following: quantum dots, color filters, and other microstructures as an optical enhancing component suitable for displaying images clearly and mitigating wrinkles when properly tensioned for display.

21. The portable, collapsible screen of claim 20, wherein said screen has at least one thin darker outer layer to mitigate ambient light.

22. The portable, collapsible screen of claim 20, further comprising:
a thin second layer on the outside surface of the screen that is painted darker, so that when light (of the projector) passes through the translucent volume of the screen from behind, its radiant flux is not significantly reduced, while ambient light is absorbed by the outside darker surface, thereby achieving higher brightness and better contrast for the displayed image.

23. The portable, collapsible screen of claim 20, further comprising:
At least one more layer of functional material to improve features of tear resistance and wrinkle resistance.

24. The portable display device of claim 2, wherein said third main strut member has a releasable connection means positioned at the non-rotating end for releasably and adjustably connecting to said screen.
